(19) United States
(12) Patent Application Publication
(10) Pub. No.: US 2013/0246514 A1
(43) Pub. Date: Sep. 19, 2013

(54) METHOD, SYSTEM, AND CLIENT FOR IMPLEMENTING GROUP

(71) Applicant: Li Zhang, Shenzhen (CN)

(72) Inventor: Li Zhang, Shenzhen (CN)

(21) Appl. No.: 13/885,948

(22) PCT Filed: Dec. 13, 2011
(86) PCT No.: PCT/CN2011/083899

§ 371 Date: May 16, 2013

(30) Foreign Application Priority Data
Jan. 20, 2011 (CN) 201110023246.7

(51) Int. Cl. H04L 29/06

(52) U.S. Cl. CPC H04L 67/42
USPC 709/203

(57) ABSTRACT

The disclosure provides a method, a system, and a client for implementing a group, wherein the method includes: setting up, by a client, a tag for a successfully created group and requesting, by the client, user information associated with the tag from a server; and initiating, by the client, an invitation for joining the according to the acquired user information. With the method for setting up the tag for the group according to the disclosure, automatic invitation of the group is well implemented, and prompt gathering of users associated with the group is realized, thereby achieving aimed prompt expansion of the group usage scale.

### TECHNICAL FIELD

The disclosure relates to the field of Instant Messenger (IM) techniques, in particular to a method, a system, and a client for implementing a group.

### BACKGROUND

Up to the current stage of development, the network IM tool has been accepted by most netizens and has become an indispensable software tool for a user, and is widely used by a user not only in daily recreations but also at work. Therefore, relatively high requirements are brought forth by the user on ease of use, stability, security of the IM tool.

In the IM tool, what have been implemented are essentially an one-to-one individual friend chat mode and an one-to-many group or discussing list message chat mode. With the continuous development of internet applications, Twitter-like micro-blog applications develop and expand continuously. In such micro-blogs, a user expresses oneself with a sentence including about 140 words, achieving prompt spread and delivery, and realizing the crossover of user message chat mode from one-to-one or one-to-many to one-to-infinity. The one-to-infinity mode means that one individual can spread message to infinite number of individuals as well as hearing from tens of thousands of users or more, which thereby raises a new requirement on applications for large number of users.

The IM is a dialogue-based interacting mode with most primitive and natural way of interaction. However, the efficiency of such interaction is low and it usually requires many dialogues to express a complete idea. Blog form of interacting is in the form of documents, and is without a definite target. Of course, the blogger has a personal style or orientation, and expresses relatively completely, but the threshold for writing a blog is relatively high. Micro-blog form of interacting uses short messages and has no definite target either, and therefore expresses an idea relatively completely; the threshold is low for writing a micro-blog, which may be a sentence or an exclamation. Therefore, a Twitter-like micro-blog delivers information more efficiently and is with lower threshold compared with an IM and a blog.

The micro-blog gains rapid increase as a new product and new application which expands the IM message spreading mechanism. Generally, for the grouping function existing in the IM tool of the relevant art, when a user creates a group in the IM and another user needs to join the group, the other user is in general informed of this group number, requests to join the group via the group number, and joins the group with the consent of the group administrator. For a user who just creates a group, such a way does not allow automatic invitation of a batch of users to join the group in the beginning, which is very inconvenient for implementation of group expansion.

### SUMMARY

Accordingly, the primary objective of the disclosure is to provide a method, a system, and a client for implementing a group which can promptly gather users associated with the group and expand the scale of the group.

To solve the aforementioned technical problem, the technical solution of the disclosure is implemented as follow:

The disclosure provides a method for implementing a group, including: setting up, by a client, a tag for a successfully created group and requesting, by the client, user information associated with the tag from a server; and initiating, by the client, an invitation for joining the according to the acquired user information.

The disclosure further provides a system for implementing a group, including a client and a server, wherein

the client is configured to set up a tag for a successfully created group, request user information associated with the tag from the server, and initiate an invitation for joining the according to the acquired user information; and

the server is configured to receive the tag from the client, store the tag required to be set up corresponding to the group, and return the user information associated with the tag to the client.

The disclosure further provides a client for implementing a group, including a group administration module, a tag administration module, an invitation module, and a message prompting module, wherein

the group administration module is configured to perform protocol command interactions with a server, create the group, initiate a command for setting up a tag to the server when the tag of the group needs to be set up, and output the returned command of successful setup of the tag to the tag administration module;

the tag administration module is configured to receive the command of successful setup of the tag, acquire the user information corresponding to the content of the tag from the server, and output the user information to the invitation module; and

the invitation module is configured to perform a cyclic scanning of a received user number list and send an invitation signalling to the server when a command to invite a user in the user information is received.

It can be seen from the technical solution provided by the disclosure that the disclosure includes: setting up, by a client, a tag for a successfully created group and requesting, by the client, user information associated with the tag from a server; and initiating, by the client, an invitation for joining the according to the acquired user information. With the method for setting up the tag for the group according to the disclosure, automatic invitation of the group is well implemented, and prompt gathering of users associated with the group is realized, thereby achieving aimed prompt expansion of the group usage scale.

### BRIEF DESCRIPTION OF THE DRAWINGS

FIG. 1 is a diagram of the compositional structure of the system for implementing a group according to the present disclosure;

FIG. 2 is a flowchart of the method for implementing a group according to the present disclosure; and

FIG. 3 is a flowchart of a specific embodiment for implementing a group according to the present disclosure.

### DETAILED DESCRIPTION

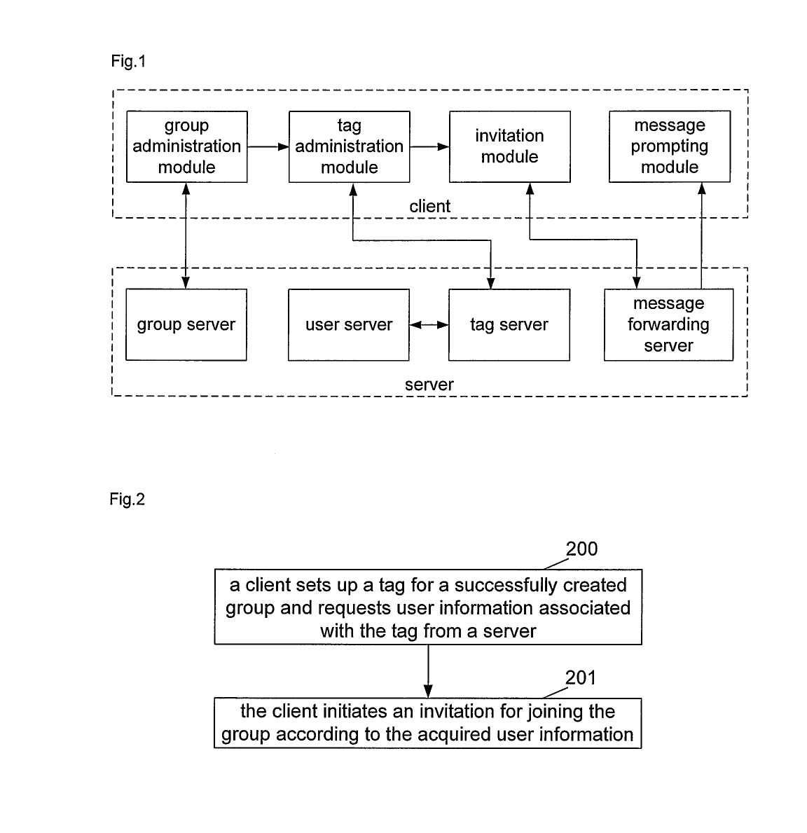

FIG. 1 is a diagram of the compositional structure of the system for implementing a group according to the present disclosure; and as shown in FIG. 1, the system mainly includes a client and a server, wherein

the client is configured to set up a tag for a successfully created group, request user information associated with the tag from the server, and initiate an invitation for joining the group according to the acquired user information; and

the server is configured to receive the tag from the client, store the tag required to be set up corresponding to the group, and return the user information associated with the tag to the client.

The client is further configured to receive corresponding group creation information, which is set up after the user logs in, and send a protocol command for creating the group to the server, and the server is further configured to create the group and return an ID of the successfully created group to the client.

The client includes a group administration module, a tag administration module, an invitation module, and a message prompting module, wherein

the group administration module is configured to perform protocol command interactions with a group server of the server, create the group, initiate a command for setting up the tag to the group server of the server when the tag of the group needs to be set up, and output the returned command of successful setup of the tag to the tag administration module;

the tag administration module is configured to receive the command of successful setup of the tag, acquire the user information, such as the user number list, corresponding to the content of the tag from a tag server of the server, and output the user information to the invitation module;

the invitation module is configured to perform a cyclic scanning of a received user number list and send an invitation signalling to a message forwarding server of the server when a command for inviting a user in the user information is received; and

the message prompting module is configured to receive a group invitation message from the message forwarding server of the server, display a prompt through an interface, and determine whether to join the current group in response to an operation of the user.

The server includes a group server, a user server, a tag server, and a message forwarding server, wherein

the group server stores information associated with the group, interact with a group administration module of the client to create the group, receive a command for setting up the tag from the group administration module of the client, store the set up tag corresponding to the group ID, and return a command of successful setup of the tag;

the tag server is configured to look up the user server, acquire user information of the set up tag, such as the user number list, and return the user information to a tag administration module of the client;

the user server stores a user reception relation of the client as well as basic user information such as user type, user tag attribute, and whether an authentication is done; and

the message forwarding server is configured to receive an invitation command from an invitation module of the client, and forward a group invitation message to the invited client.

The client of the present disclosure may be but is not limited to an IM client and a micro-blog terminal.

Accordingly, the disclosure further discloses a client for implementing a group, including a group administration module, a tag administration module, and an invitation module, wherein

the group administration module is configured to perform protocol command interactions with a server, create the group, initiate a command for setting up a tag to the server when the tag of the group needs to be set up, and output the command of successful setup of the tag returned by the server to the tag administration module;

the tag administration module is configured to receive the command of successful setup of the tag, acquire the user information corresponding to the content of the tag from the server, and output the user information to the invitation module; and

the invitation module is configured to perform a cyclic scanning of a received user number list and send an invitation signalling to the server when a command to invite a user in the user information is received.

The client may further include a message prompting module configured to receive a group invitation message from the server, display a prompt through an interface, and determine whether to join the current group in response to an operation of the user.

FIG. 2 is a flowchart of the method for implementing a group according to the present disclosure, wherein the method mainly includes:

Step 200: setting up, by a client, a tag for a successfully created group and requesting, by the client, user information associated with the tag from a server, wherein the user information may be a user account list. This step specifically includes that:

after the user logs in the client such as a micro-blog terminal, the user sets up the corresponding group creation information via the client, the client sends to the server a protocol command for creating the group; after the group is successfully created, the server returns the ID of the successfully created group; the user sets up, via the client, the corresponding tag, for example, NBA fans, for the successfully created group, and the client initiates a command for setting up the tag;

after receiving the command for setting up the tag, the server stores the tag required to be set up corresponding to the group ID, and returns to the client a command of successful setup of the tag;

after successfully setting up the tag for the created group, the client acquires from the server the user information associated with the tag, such as the user account list, wherein the user account list returned by the server may be ordered according to whether a user is a celebrity, the activeness in message posting, and the like.

Step 201: initiating, by the client, an invitation for joining the group according to the acquired user information. This step specifically includes that:

after acquiring user information associated with the tag such as the user account list, the client displays via a window the user account list to the user, who may select from the user account list a user to which a protocol command for inviting to join the group is required to be sent, and may send an invitation signalling to the selected user via the server.

Thus, after receiving the invitation signalling, the client of the selected user may display via a window the invitation signalling to the selected user, who can thereby determine whether to join the group according to the requirement of the selected user.

With the method for setting up the tag for the group according to the disclosure, automatic invitation of the group is well implemented, and prompt gathering of users associated with the group is realized, thereby achieving aimed prompt expansion of the group usage scale.

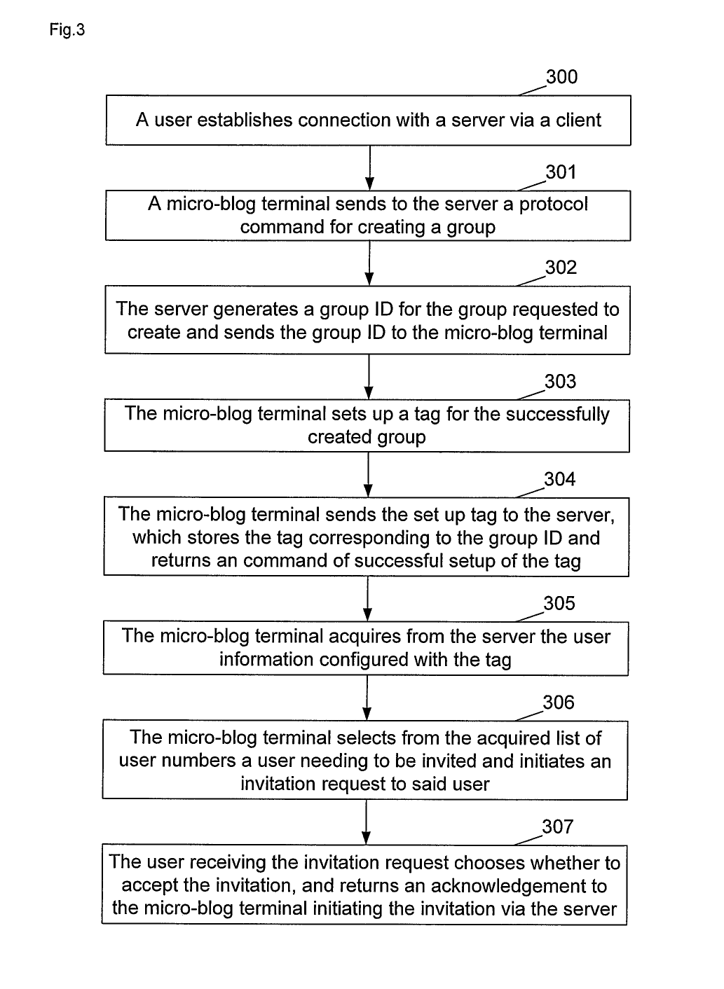

FIG. 3 is a flowchart of an embodiment for implementing a group according to the present disclosure, and as shown in FIG. 3, assuming that the client is a micro-blog terminal, the embodiment includes the following steps.

Step 300: A connection is established between the micro-blog terminal and a server.

In this step, the micro-blog terminal corresponding to a user sends the user account and password to the server, passes the authentication and logs in successfully, and establishes a connection channel with the server; the micro-blog terminal may subsequently ensure the connection with the server by sending a heartbeat package at a regular time interval. The specific implementation of this step is a conventional technical means of an ordinarily skilled person in the art and is not elaborated here.

Step 301: The micro-blog terminal sends to the server a protocol command for creating a group.

In this step, the micro-blog terminal monitors a user operation such as a mouse clicking, and creates a corresponding group data fill-in interface after determining that the user clicks “creating group”, at which point, the user may set up group related information such as the group name, group introduction, and the like via the provided interface, and pack the set up group related information into a data packet, encrypt the packet, and send it to the server to request to create the group.

Step 302: The server generates a group ID for the group requested to create and sends the group ID to the micro-blog terminal.

In this step, after receiving the request for creating the group, the server decrypts the received data packet, extracts the group related information from the valid data packet, stores the information into the corresponding data row in the group data table, and generates the corresponding group ID. If the operation is successful, the group ID is returned to the micro-blog terminal; otherwise a failure prompt is returned to the micro-blog terminal.

There are many ways to implement the encryption and decryption in this embodiment, which are conventional technical means of an ordinarily skilled person in the art, and the specific implementation is not defined here, nor is it intended to limit the scope of the disclosure.

Step 303: The micro-blog terminal sets up a tag for the successfully created group.

In this step, after receiving a command of successful operation returned by the server, the micro-blog terminal extracts the group ID in the data packet and stores the ID locally, and simultaneously monitors a user mouse message to determine whether the user sets up the group tag by a clicking operation, if so, the micro-blog terminal creates a tag setup interface, such that the user may set up a corresponding tag content for the group via the interface.

Step 304: The micro-blog terminal sends the set up tag to the server, which stores the group ID corresponding to the tag and returns a command of successful setup of the tag to the client.

In this step, after the user sets up the tag via the micro-blog terminal, the micro-blog terminal sends to the server a protocol command to set up a group tag attribute, wherein the command carries an encrypted data packet including the group ID and the corresponding tag, and the server decrypts the received data packet, extracts the group ID therein, looks up a data base according to the group ID, stores the tag set up by the user in a corresponding data row, and returns a protocol command of successful setup of the tag.

Step 305: The micro-blog terminal acquires from the server the user information provided with the tag.

In this step, after receiving the command of successful setup of the tag, the micro-blog terminal sends to the server a protocol command to acquire the user number list corresponding to the tag, and the server looks up the user information that has been provided with the tag, acquires a list of the user numbers that have been provided with the tag, and returns the list to the micro-blog terminal.

Step 306: The micro-blog terminal selects from the acquired list of user numbers a user needing to be invited and initiates an invitation request to said user.

In this step, the micro-blog terminal extracts the list of user numbers to look up the micro-blog data, creates an interface for automatic invitation, and displays the listed information of user numbers to the user, and the user may check those users to be invited according to the requirement of the user; the list of numbers of users to be invited checked by the user is scanned, and the group name, the nickname and the number of the user initiating the invitation, the number of a user receiving the invitation, and a prompt information are sent to the server, which forwards the received invitation request to the login address of the micro-blog terminal corresponding to the number of the user receiving the invitation.

Step 307: The user receiving the invitation request chooses whether to accept the invitation, and returns an acknowledgement to the micro-blog terminal initiating the invitation via the invited micro-blog terminal where the user is located and the server.

In this step, the micro-blog terminal receiving the invitation extracts the message including the group name and the nick name and number of the user initiating the invitation, etc. by decrypting the received message data packet, and creates a corresponding group invitation interface, and the user affirms whether to join the micro-blog group initiating the invitation through the information displayed by the interface. If the user is to join the group, the user may automatically join the micro-blog group to receive and process a micro-blog message; otherwise the user just refuses.

What described are just preferred embodiments of the disclosure and are not intended to limit the scope of the disclosure, and any modification, equivalent replacement, improvement, or the like made within the spirit and principle of the disclosure should fall within the scope of the disclosure.

1. A method for implementing a group, comprising:
setting up, by a client, a tag for a successfully created group and requesting, by the client, user information associated with the tag from a server; and
initiating, by the client, an invitation for joining the group according to the acquired user information.

2. The method according to claim 1, further comprising:
setting up corresponding group creation information;
sending, by the client, a protocol command for creating the group to the server; and
returning, by the server, a group ID of the successfully created group to the client.

3. The method according to claim 2, wherein setting up, by a client, a tag for a successfully created group comprises:
setting up, by the user, the corresponding tag for the successfully created group through the client, and initiating, by the user, a command for setting up the tag to the server; and
receiving, by the server, the command for setting up the tag, and storing, by the server, the tag required to be set up corresponding to the group ID, and returning, by the server, a command of successful setup of the tag.

4. The method according to claim 1, wherein requesting, by the client, user information associated with the tag from a server comprises:
requesting and acquiring, by the client, the user information associated with the tag from the server, wherein the user information includes a user account list.

5. The method according to claim 2, wherein initiating, by the client, an invitation for joining the group according to the acquired user information comprises:
displaying, by the client, the acquired user information associated with the tag to the user; and
selecting, by the user, from the acquired user information a user to which a protocol command for inviting to join the group is required to be sent, and sending, by the user, an invitation signalling to the selected user via the server.

6. The method according to claim 5, further comprising:
receiving, by the client of an invited user, the invitation signalling, and determining, by the client of the invited user, whether to join the group according to the requirement of the invited user.

7. A system for implementing a group, comprising a client and a server, wherein
the client is configured to set up a tag for a successfully created group, request user information associated with the tag from the server, and initiate an invitation for joining the group according to the acquired user information; and
the server is configured to receive the tag from the client, store the tag required to be set up corresponding to the group, and return the user information associated with the tag to the client.

8. The system according to claim 7, wherein the client is further configured to set up corresponding group creation information and send a protocol command for creating the group to the server; and
the server is further configured to create the group and return an ID of the successfully created group to the client.

9. The system according to claim 7, wherein the client comprises a group administration module, a tag administration module, an invitation module, and a message prompting module, wherein
the group administration module is configured to perform protocol command interactions with a group server of the server, create the group, initiate a command for setting up the tag to the group server of the server when the tag of the group needs to be set up, and output the returned command of successful setup of the tag to the tag administration module;
the tag administration module is configured to receive the command of successful setup of the tag, acquire the user information corresponding to the tag from a tag server of the server, and output the user information to the invitation module;
the invitation module is configured to perform a cyclic scanning of a received user number list and send an invitation signalling to a forwarding server of the server when a command for inviting a user in the user information is received; and
the message prompting module is configured to receive a group invitation message from the forwarding server of the server, display a prompt through an interface, and determine whether to join the current group in response to an operation of the user.

10. The system according to claim 7, wherein the server comprises a group server, a user server, a tag server, and a message forwarding server, wherein
the group server is configured to store information associated with the group, interact with a group administration module of the client to create the group, receive a command for setting up the tag from the group administration module of the client, store the set up tag corresponding to the group ID, and return a command of successful setup of the tag;
the tag server is configured to look up the user server, acquire user information of the set up tag, and return the user information to a tag administration module of the client;
the user server is configured to store a user reception relation of the client as well as information on a user type, a user tag attribute, and whether an authentication is done; and
the message forwarding server is configured to receive an invitation command from an invitation module of the client, and forward a group invitation message to the invited client.

11. A client for implementing a group, comprising a group administration module, a tag administration module, an invitation module, and a message prompting module, wherein
the group administration module is configured to perform protocol command interactions with a server, create the group, initiate a command for setting up a tag to the server when the tag of the group needs to be set up, and output the returned command of successful setup of the tag to the tag administration module;
the tag administration module is configured to receive the command of successful setup of the tag, acquire the user information corresponding to the tag from the server, and output the user information to the invitation module; and
the invitation module is configured to perform a cyclic scanning of a received user number list and send an invitation signalling to the server when a command to invite a user in the user information is received.

12. The client according to claim 11, further comprising:
the message prompting module configured to receive a group invitation message from the server, display a prompt through an interface, and determine whether to join the current group in response to an operation the user.

13. The method according to claim 2, wherein requesting, by the client, user information associated with the tag from a server comprises:
requesting and acquiring, by the client, the user information associated with the tag from the server, wherein the user information includes a user account list.

14. The method according to claim 3, wherein initiating, by the client, an invitation for joining the group according to the acquired user information comprises:
displaying, by the client, the acquired user information associated with the tag to the user; and
selecting, by the user, from the acquired user information a user to which a protocol command for inviting to join the group is required to be sent, and sending, by the user, an invitation signalling to the selected user via the server.

15. The method according to claim 14, further comprising:
receiving, by the client of an invited user, the invitation signalling, and determining, by the client of the invited user, whether to join the group according to the requirement of the invited user.

16. The system according to claim 8, wherein the client comprises a group administration module, a tag administration module, an invitation module, and a message prompting module, wherein
the group administration module is configured to perform protocol command interactions with a group server of the server, create the group, initiate a command for setting up the tag to the group server of the server when the tag of the group needs to be set up, and output the returned command of successful setup of the tag to the tag administration module;
the tag administration module is configured to receive the command of successful setup of the tag, acquire the user information corresponding to the tag from a tag server of the server, and output the user information to the invitation module;
the invitation module is configured to perform a cyclic scanning of a received user number list and send an invitation signalling to a forwarding server of the server when a command for inviting a user in the user information is received; and
the message prompting module is configured to receive a group invitation message from the forwarding server of the server, display a prompt through an interface, and determine whether to join the current group in response to an operation of the user.

17. The system according to claim 8, wherein the server comprises a group server, a user server, a tag server, and a message forwarding server, wherein
the group server is configured to store information associated with the group, interact with a group administration module of the client to create the group, receive a command for setting up the tag from the group administration module of the client, store the set up tag corresponding to the group ID, and return a command of successful setup of the tag;
the tag server is configured to look up the user server, acquire user information of the set up tag, and return the user information to a tag administration module of the client;
the user server is configured to store a user reception relation of the client as well as information on a user type, a user tag attribute, and whether an authentication is done; and
the message forwarding server is configured to receive an invitation command from an invitation module of the client, and forward a group invitation message to the invited client.
